(19) United States
(12) Patent Application Publication
(10) Pub. No.: US 2020/0001715 A1
(43) Pub. Date: Jan. 2, 2020

(54) CHILD EMERGENCY IGNITION OVERRIDE SYSTEM AND METHOD

(71) Applicant: Kelvin Ray Brown, San Antonio, TX (US)

(72) Inventor: Kelvin Ray Brown, San Antonio, TX (US)

(21) Appl. No.: 16/460,785

(22) Filed: Jul. 2, 2019

Related U.S. Application Data
(60) Provisional application No. 62/693,380, filed on Jul. 2, 2018.

(51) Int. Cl. B60K 28/10; B60N 2/00; B60H 1/00; B60K 28/04; B60Q 5/00; B60Q 9/00

(52) U.S. Cl. CPC B60K 28/10; B60N 2/002; B60Q 9/00; B60K 28/04; B60Q 5/005; B60H 1/00742

(57) ABSTRACT

A vehicle ignition override system which may be designed for emergency situations, such as a child being left in the vehicle unattended during elevated temperature weather conditions. The system may include a temperature sensor to detect elevated heat conditions, an automatic ignition override switch which may start the vehicle and activate an air-conditioning system. The system may also include a warning alarm which may produce a sound notifying nearby pedestrians that a child was left in the car. The system may even further include a remote notification signal which may be sent to the driver via a smart device or vehicle dongle.

### CROSS-REFERENCE TO RELATED APPLICATION(S)

The present application is related to and claims priority to U.S. Provisional Patent Application No. 62/693,380 filed Jul. 2, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of communications: electrical of existing art and more specifically relates to a child emergency ignition override system.

### RELATED ART

Many people in modern society travel between locations using a vehicle. Whether the operators/drivers are rushed or distracted, parents or caregivers may accidentally leave their child in a hot car. Depending how long parents or caregivers are away, the temperature inside the vehicle can become increasingly hot to the point of medical distress, resulting in severe injuries and possibly even death. A suitable solution is desired.

U.S. Pat. No. 8,841,997 to Orlando L. Silveira relates to a vehicle alarm system for alerting a vehicle operator that the vehicle is still occupied with a child or pet. The described vehicle alarm system for alerting a vehicle operator that the vehicle is still occupied with a child or pet includes a portable vehicle alarm system which alerts a vehicle operator of the presence of a child/pet left in the vehicle. The system includes at least one first portable wireless alarm unit in communication with a second portable wireless unit. The first and second portable wireless alarm units include a microprocessor in communication with a transmitter and receiver, having a power supply. The first portable unit is located on a key chain. The second wireless unit has attachment means for attachment to a seat belt associated with a child's car seat or a pet's collar. An activation sensor detects a disengagement action related to the vehicle, including powering-off of the vehicle ignition or unbuckling of the driver's seat belt. A distance sensor has a selected range. If the range is exceeded, an audible alarm is actuated from the first unit.

### SUMMARY OF THE INVENTION

In view of the foregoing disadvantages inherent in the known electrical communications art, the present disclosure provides a novel child emergency ignition override system. The general purpose of the present disclosure, which will be described subsequently in greater detail, is to provide a safe, effective and efficient child emergency ignition override system.

The present invention monitors rising temperature levels inside a vehicle and detects a child's movement, signifying the child has been left in the vehicle unattended. The device interacts with the automatic ignition override switch, which sends a wireless signal to the emergency ignition override chip and activates the air-conditioning system. It includes a warning alarm system that produces a sound notifying nearby pedestrians that a child was left unattended in the car. The device sends a notification to drivers via their smartphone or other device that their child was left in their vehicle. The present invention saves children's lives and prevents tragedies to child occupants of vehicles.

A child emergency ignition override system is disclosed herein in a preferred embodiment the system comprising: a car seat assembly having a car seat; a first-electronic-device including a temperature sensor; and a motion detector; a sensor pad; an emergency ignition override chip in communication with the first-electronic-device, a host vehicle electrical and powering system, the sensor pad, and a second-electronic-device; an audible alarm means (powered via the host vehicle); wherein the sensor pad is able to sense a presence of a seat-occupant; the car seat is positioned above the sensor pad during use.

The child emergency ignition override system is configured to be activated by at least one signal, the powering system of the host vehicle is then caused to start and simultaneously operates an air-conditioning-system to cool an interior of the host vehicle to promote safety of the seat-occupant. The motion detector is preferably secured in a bracket on a right side of the car seat to sense motion of the seat-occupant (the seat-occupant comprising a child). The first-electronic-device comprises a tablet; the sensor pad comprises at least one weight-sensor; and the second-electronic-device comprises a smart-phone able to receive and transmit remote communications (via means known in the art). The emergency ignition override chip is installed in proximity of a driver of the host vehicle.

The smart-phone is equipped with a software application configured to control the host vehicle electrical and powering system and is in communication with the emergency ignition override chip, the first-electronic-device, and the sensor pad. The audible alarm means is located on the host vehicle; wherein the audible alarm means is able to communicate an emergency condition present to nearby pedestrians that a child was left unattended in the host vehicle and/or to communicate with at least one roadside-assistance company (authorities) as needed. The first-electronic-device is configured to first communicate with the driver via the smart-phone.

The emergency ignition override chip causes a green-illumination to be emitted when in a safe-to-use-condition and an intermittent red-illumination to be emitted when an error occurs. The host vehicle comprises an on-board computer.

A method of use for the child emergency ignition override system is also disclosed herein, the method comprising the steps of: providing a child emergency ignition as disclosed herein; syncing a smart-phone comprising a software application with the emergency ignition override chip and an on-board computer of the host vehicle such that the software application is able to remotely control the powering system of the host vehicle to cause to start and simultaneously operate an air-conditioning-system to cool an interior of the host vehicle to promote safety of the seat-occupant. The method may further comprise the steps of sensing a presence of a seat-occupant via the first-electronic-device and/or the sensor pad; and activating an alarm (audible or non-audible) based on a provided signal.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a child emergency ignition override system, constructed and operative according to the teachings of the present disclosure.

FIG. 1 is a perspective view of the child emergency ignition override system during an ‘in-use’ condition, according to an embodiment of the disclosure.

FIG. 2 is a perspective view of the child emergency ignition override system of FIG. 1, according to an embodiment of the present disclosure.

FIG. 3 is a perspective view of the child emergency ignition override system of FIG. 1, according to an embodiment of the present disclosure.

FIG. 4 is a perspective view of the child emergency ignition override system of FIG. 1, according to an embodiment of the present disclosure.

FIG. 5 is a flow diagram illustrating a method of use for the child emergency ignition override system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electrical communications and more particularly to a child emergency ignition override system as used to improve the safety of children.

Generally, Child Emergency Ignition Override System is a vehicle child emergency ignition override system that is designed for emergency situations, such as a child being left in a vehicle unattended during hot weather conditions. This innovative device features a smart car seat with a tablet with a built-in temperature sensor and motion detector, secured in a bracket on the right side of the seat. Underneath the fabric of the car seat can be electronic sensor buttons or a sensor pad that is zipped in or buttoned down. An emergency ignition override chip, installed underneath the dashboard or steering wheel, can have a green program light that indicates the product is safe to use. When there is a malfunction within the chip, it can cause a beep and flash red lights. An alarm is professionally installed in communication with the engine (powering system and electrical system of the vehicle), and a smartphone can be paired to the system via a downloaded application.

In use, the tablet can detect (sense) rising temperatures and motion within a vehicle to determine that a child has been left behind. Then, the system can interact with the automatic ignition override switch, which can send a wireless signal to the emergency ignition override chip. This chip will start the vehicle and activate the air-conditioning system. Further, the system can trigger the alarm, notifying nearby pedestrians that a child was left unattended in the car, and send a notification to the driver via the paired smartphone. The system can also notify roadside-assistance companies, which can alert the authorities to diffuse the situation if parents or caregivers aren't readily available.

The sensor pad can: detect and measure relative change in force or applied load; detect and measure the rate of change(s) in applied load; identify force threshold and trigger an appropriate reaction; and detect contact and/or touch. It is known in the art that pressure sensor pads may be created with four source components: 1) a force (or pressure) sensor (load cells, strain gauges, MEM microelectromechanical systems), and FSR (force-sensitive resistors); 2) interface circuit (microcontroller); 3) a method of capture or display feedback from the pressure sensor pad; and 4) a power supply. The power supply may be from the host vehicle or onboard the car seat. The pressure and threshold may be adjusted as needed.

Motherboard function: The ECIO motherboard houses and/or it holds together multiple ECIO crucial components of its computer system, including the central processing unit (CPU), memory/storage and connectors for input and output devices for the ECIO proper usage for the functions described herein. The ECIO's central processing unit, also called a central processor or main processor, is the electronic circuitry within the Emergency Child ignition Override Systems computer that carries out the instructions of a computer program by performing the basic arithmetic, logic, controlling, and input/output operations specified by the instructions. Electronic Temperature Gage: a wire runs from the gage box. The wire has a prong on the end that plugs into the computer and registers via the processing thermostat either a dangerous rising temperature or a dangerous low temperature. The processing center activates sending a transmission from the CPU processing center to a wiring bus center. From the wire bus each individual wire leads to the remote buttons situated throughout the child's seat fabric. If the buttons have the slightest continual pressure enforced upon them, a sign is sent back to the ECIO computer process where the processor is pre-programmed to carry out a function of activating the BLUETOOTH. The ECIO CPU receives input from the election temperature gauge The Bluetooth is housed within the smart seat and its used to send the signal to the ECIO component box. ECIO Box: this is the box is the main component that's used to start the engine (powering system of the host vehicle), when it receives the signal from the Bluetooth it switches on the appropriate systems. The ECIO box must be connected to the ignition switch, the power wire, the ignition wire, the starter wire, the brake wire, the car's ground wire, and the tachometer wire followed by the A/C computer. When the starter receives the signal from the Bluetooth and ECIO component box, it switches on all these systems. It allows the engine to start, which allows preset settings like heat and cool to come on and begin to work. It also locks the doors and blinks the lights for visual confirmation, while the audible sound warns the people passing by that a child is in the vehicle.

To prevent theft of the host vehicle a variety of failsafe devices prevent this from happening. The first thing the ECIO remote starter does is lock all the car doors. Secondly, as there is no key in the ignition, it is impossible to shift gears on the car to take it from “park” to “drive.” Thirdly, the second someone presses on the brake pedal without the key in the ignition, the remote starter shuts the engine off. A tamper switch is also placed under the hood of the car, shutting down the engine if someone opens the hood after the car has been remotely started. All of these effectively ensure that nobody but the car owner will be able to drive the host vehicle after it has been started via the remote control.

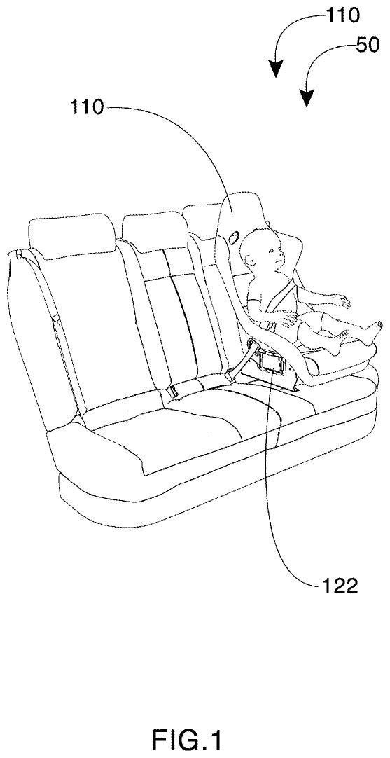

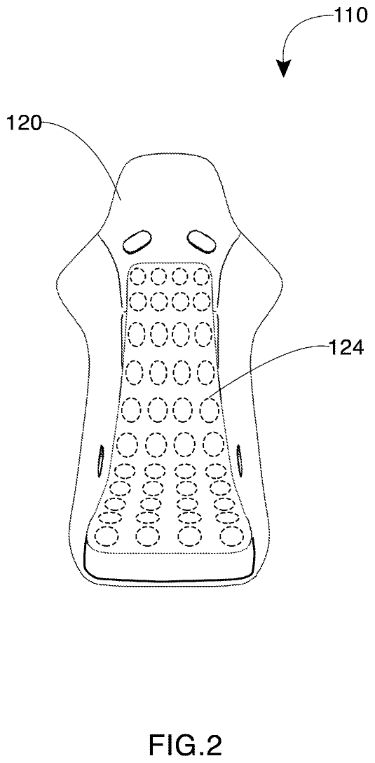

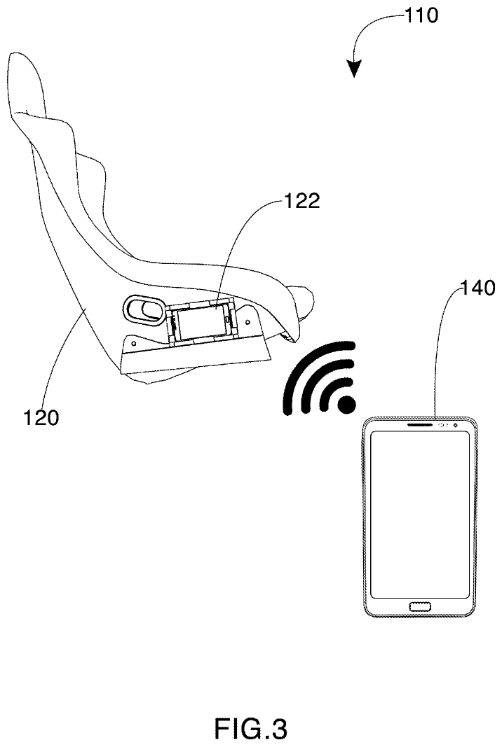

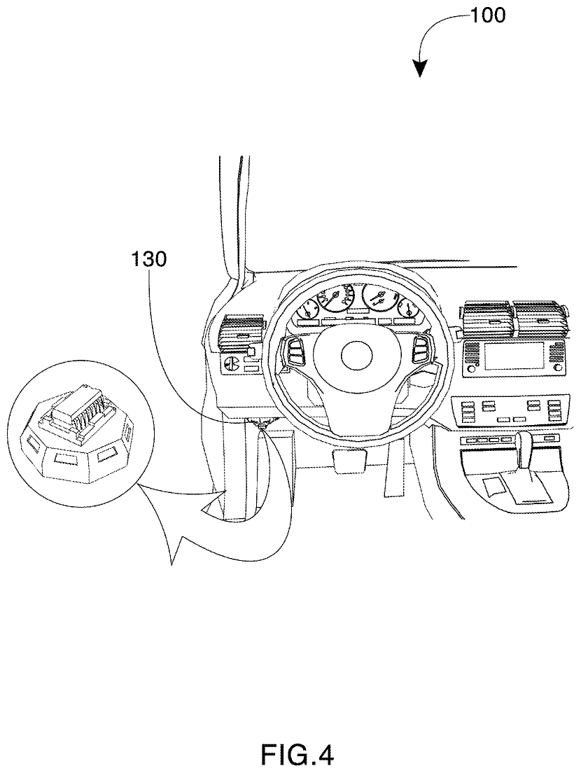

Referring now more specifically to the drawings by numerals of reference, there is shown in FIGS. 1-4, various views of a child emergency ignition override system 100.

FIG. 1 shows a child emergency ignition override system 100 during an ‘in-use’ condition 50, according to an embodiment of the present disclosure. Here, the child emergency ignition override system 100 may be beneficial for use by a user to promote vehicle safety for child occupants. As illustrated, the child emergency ignition override system 100 may include a car seat assembly 110 having a car seat 120; a first-electronic-device 122 including a temperature sensor; and a motion detector; a sensor pad 124; an emergency ignition override chip 130 in communication with the first-electronic-device 122, a host vehicle electrical and powering system, the sensor pad 124, and a second-electronic-device 140; wherein the sensor pad 124 is able to sense a presence of a seat-occupant (mass, weight, movement of the child or other).

Relationally speaking, the car seat 120 is positioned above the sensor pad 124 during use (which may be integral with the seat of the vehicle or coupled to as described above). The child emergency ignition override system 100 is configured to be activated by at least one signal from the powering system of the host vehicle and then caused to start and simultaneously operate an air-conditioning-system (of the host vehicle) to cool an interior of the host vehicle to promote safety of the seat-occupant. Communication as to starting and adjusting air-conditioning is provided my means well known in the art.

The motion detector is preferably secured in a bracket on a right side of the car seat to sense motion of the seat-occupant; the seat-occupant comprising a child. The first-electronic-device 122 comprises a tablet, as shown but may comprise other electronic device able to transmit and receive communication signals and to sense temperature and movement. The sensor pad 124 preferably comprises at least one weight-sensor. The second-electronic-device 140 comprises a smart-phone able to receive and transmit remote communications.

Referring now to the emergency ignition override chip 130; emergency ignition override chip 130 is preferably installed in proximity of a driver of the host vehicle on a dashboard, steering wheel or the like. The smart-phone comprises a software application configured to control the host vehicle electrical and powering system and is in communication with the emergency ignition override chip 130, the first-electronic-device 122, and the sensor pad 124. Those with ordinary skill in the art will now appreciate that upon reading this specification and by their understanding the art of communication and software applications, sending and receiving data as described herein, methods of communication will be understood by those knowledgeable in such art.

The child emergency ignition override system 100 may further comprise an audible alarm means on the host vehicle; wherein the audible alarm means is able to communicate an emergency condition present to nearby pedestrians that a child was left unattended in the host vehicle via speakers or the like. The first-electronic-device 122 is configured to communicate with at least one roadside-assistance company. The first-electronic-device 122 is configured to communicate with the driver (first option) via the smart-phone.

The emergency ignition override chip 130 causes a green-illumination to be emitted when in a safe-to-use-condition and an intermittent red-illumination to be emitted when an error occurs. The host vehicle comprises an on-board computer to work with the child emergency ignition override system 100.

According to one embodiment, the child emergency ignition override system 100 may be arranged as a kit. In particular, the child emergency ignition override system 100 may further include a set of instructions. The instructions may detail functional relationships in relation to the structure of the child emergency ignition override system 100 such that the child emergency ignition override system 100 can be used, maintained, or the like, in a preferred manner.

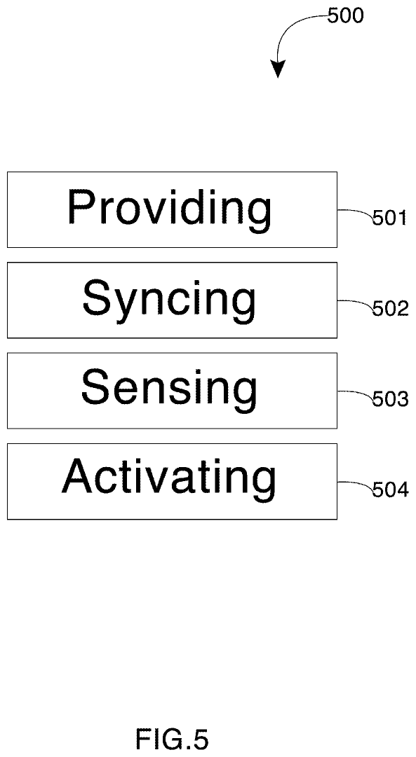

FIG. 5 is a flow diagram illustrating a method for use 500 of the child emergency ignition override system 100, according to an embodiment of the present disclosure. In particular, the method for use 500 may include one or more components or features of the child emergency ignition override system 100 as described above. As illustrated, the method of use 500 may include the steps of: step one 501, providing a child emergency ignition as disclosed herein; step two 502 syncing a smart-phone comprising a software application with the emergency ignition override chip and an on-board computer of the host vehicle such that the software application is able to remotely control the powering system of the host vehicle to cause to start and simultaneously operate an air-conditioning-system to cool an interior of the host vehicle to promote safety of the seat-occupant. The method may further comprise the steps of: step three 503 sensing a presence of a seat-occupant via the first-electronic-device and/or the sensor pad; and step four 504 (the system) activating an alarm (audible or non-audible) based on a provided signal. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use the child emergency ignition override system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A child emergency ignition override system, the system comprising:
a car seat assembly having
a car seat;
a first-electronic-device including
a temperature sensor; and
a motion detector;
a sensor pad;
an emergency ignition override chip in communication with said first-electronic-device, a host vehicle electrical and powering system, said sensor pad, and a second-electronic-device;
wherein said sensor pad is able to sense a presence of a seat-occupant;
wherein the car seat is positioned above said sensor pad during use; and
wherein when said child emergency ignition override system is configured to be activated by at least one signal said powering system of said host vehicle is then caused to start and simultaneously operates an air-conditioning-system to cool an interior of said host vehicle to promote safety of said seat-occupant.

2. The child emergency ignition override system of claim 1, wherein the motion detector is secured in a bracket on a right side of the car seat to sense motion of said seat-occupant, said seat-occupant comprising a child.

3. The child emergency ignition override system of claim 1, wherein said first-electronic-device comprises a tablet.

4. The child emergency ignition override system of claim 1, wherein said sensor pad comprises at least one weight-sensor.

5. The child emergency ignition override system of claim 1, wherein the second-electronic-device comprises a smart-phone able to receive and transmit remote communications.

6. The child emergency ignition override system of claim 5, wherein the emergency ignition override chip is installed in proximity of a driver of said host vehicle.

7. The child emergency ignition override system of claim 6, wherein the proximity of the driver is a dashboard.

8. The child emergency ignition override system of claim 6, wherein the proximity of the driver is a steering wheel.

9. The child emergency ignition override system of claim 6, wherein the smart-phone comprises a software application configured to control said host vehicle electrical and powering system and is in communication with said emergency ignition override chip, said first-electronic-device, and said sensor pad.

10. The child emergency ignition override system of claim 9, further comprising an audible alarm means on said host vehicle.

11. The child emergency ignition override system of claim 10, wherein the audible alarm means is able to communicate an emergency condition present to nearby pedestrians that a child was left unattended in said host vehicle.

12. The child emergency ignition override system of claim 3, wherein the first-electronic-device is configured to communicate with at least one roadside-assistance company.

13. The child emergency ignition override system of claim 3, wherein the first-electronic-device is configured to communicate with said driver via said smart-phone.

14. The child emergency ignition override system of claim 8, wherein the emergency ignition override chip causes a green-illumination to be emitted when in a safe-to-use-condition.

15. The child emergency ignition override system of claim 8, wherein the emergency ignition override chip causes an intermittent red-illumination to be emitted when an error occurs.

16. The child emergency ignition override system of claim 1, wherein said host vehicle comprises an on-board computer.

17. A child emergency ignition override system, the system comprising:
a car seat assembly having
a car seat;
a first-electronic-device including
a temperature sensor; and
a motion detector;
a sensor pad;
an emergency ignition override chip in communication with said first-electronic-device, a host vehicle electrical and powering system, said sensor pad, and a second-electronic-device;
an audible alarm means;
wherein said sensor pad is able to sense a presence of a seat-occupant;
wherein the car seat is positioned above said sensor pad during use;
wherein when said child emergency ignition override system is configured to be activated by at least one signal said powering system of said host vehicle is then caused to start and simultaneously operates an air-conditioning-system to cool an interior of said host vehicle to promote safety of said seat-occupant;
wherein the motion detector is secured in a bracket on a right side of the car seat to sense motion of said seat-occupant, said seat-occupant comprising a child;
wherein said first-electronic-device comprises a tablet;
wherein said sensor pad comprises at least one weight-sensor;
wherein the second-electronic-device comprises a smart-phone able to receive and transmit remote communications;
wherein the emergency ignition override chip is installed in proximity of a driver of said host vehicle;
wherein the smart-phone is equipped with a software application configured to control said host vehicle electrical and powering system and is in communication with said emergency ignition override chip, said first-electronic-device, and said sensor pad;
wherein the audible alarm means is located on said host vehicle;
wherein the audible alarm means is able to communicate an emergency condition present to nearby pedestrians that a child was left unattended in said host vehicle;
wherein the first-electronic-device is configured to communicate with at least one roadside-assistance company as needed;
wherein the first-electronic-device is configured to communicate with said driver via said smart-phone;
wherein the emergency ignition override chip causes a green-illumination to be emitted when in a safe-to-use-condition and an intermittent red-illumination to be emitted when an error occurs; and
wherein said host vehicle comprises an on-board computer.

18. The child emergency ignition override system of claim 17, further comprising set of instructions; and
wherein the child emergency ignition override system is arranged as a kit.

19. A method of use for the child emergency ignition override system, the method comprising the steps of:
providing a child emergency ignition override system comprising:
a car seat assembly having
a car seat;
a first-electronic-device including
a temperature sensor; and
a motion detector;
a sensor pad;
an emergency ignition override chip in communication with said first-electronic-device, a host vehicle electrical and powering system, said sensor pad, and a second-electronic-device;
an audible alarm means; and
syncing a smart-phone comprising a software application with said emergency ignition override chip and an on-board computer of said host vehicle such that said software application is able to remotely control said powering system of said host vehicle to cause to start and simultaneously operate an air-conditioning-system to cool an interior of said host vehicle to promote safety of said seat-occupant.

20. The method of claim 19, further comprising the steps of:
sensing a presence of a seat-occupant via said first-electronic-device and/or said sensor pad; and
activating an alarm based on a provided signal.
